(19) United States
(12) Patent Application Publication
(10) Pub. No.: US 2015/0242179 A1
(43) Pub. Date: Aug. 27, 2015

(54) AUGMENTED PERIPHERAL CONTENT USING MOBILE DEVICE

(71) Applicant: SMART Technologies ULC, Calgary (CA)

(72) Inventors: PHIL BENSON, Calgary (CA); MIGO ARANETA, Calgary (CA); GRANT MCGIBNEY, Calgary (CA); ANGELA THOMAS, Calgary (CA)

(21) Appl. No.: 14/186,374

(22) Filed: Feb. 21, 2014

(51) Int. Cl. G06F 3/14; G06F 3/0485

(52) U.S. Cl. CPC G06F 3/1462; G06F 3/0485

(57) ABSTRACT

A computer-implemented method for displaying a canvas on a portable computing device is described. The portable computing device comprises a camera, a screen, and a network interface. The method comprises using a camera to capture an image of a display, displaying a portion of the canvas, on the screen. A position of the display relative to edges of the screen is determined. The position of the display to determine screen surface available is used for displaying an additional portion of the canvas. The additional portion of the canvas is retrieved and both the portion of the canvas and the additional portion of the canvas are displayed on the screen.

The subject application relates generally to an interactive input system, and in particular, to a system and method for displaying peripheral content of a display screen using a mobile device.

### BACKGROUND OF THE INVENTION

Interactive input systems that allow users to inject input such as for example digital ink, mouse events etc. into an application program using an active pointer (e.g. a pointer that emits light, sound or other signal), a passive pointer (e.g., a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies ULC of Calgary, Alberta, Canada, assignee of the subject application, the entire contents of which are incorporated herein by reference; touch systems comprising touch panels employing electromagnetic, capacitive, acoustic or other technologies to register pointer input; tablet and laptop personal computers (PCs); personal digital assistants (PDAs) and other handheld devices; and other similar devices.

Although efforts have been made to make software applications more user-friendly, it is still desirable to improve user experience of software applications used in interactive input systems. It is therefore an object to provide a novel method for manipulating a graphical user interface in an interactive input system.

### SUMMARY OF THE INVENTION

In accordance with one aspect of an embodiment, there is provided a computer-implement method for displaying a canvas on a portable computing device comprising a camera, a screen, and a network interface, the method comprising: using a camera to capture an image of a display displaying a portion of the canvas on the screen; determining a position of the display relative to edges of the screen; using the position of the display to determine screen surface available for displaying an additional portion of the canvas; retrieving the additional portion of the canvas; and displaying both the portion of the canvas and the additional portion of the canvas on the screen.

In accordance with another aspect of an embodiment, there is provided a portable computing device for displaying a canvas, the portable computing device comprising: a screen; a camera configured to capture an image of a display, displaying a portion of the canvas; a memory comprising instruction; and a processor configure to: determine a position of the display relative to edges of the screen; use the position of the display to determine screen surface available for displaying an additional portion of the canvas; retrieve the additional portion of the canvas; and display both the portion of the canvas and the additional portion of the canvas on the screen.

In accordance with another aspect of an embodiment, there is provided a computer-implemented method for displaying a canvas on a portable computing device comprising a screen, and a network interface, the method comprising: determining, at a computing device, a portion of the canvas that is displayed on an interactive surface of an interactive display device; retrieving data associated with the portion of the canvas that is displayed on the interactive surface based on a predefined identification point; and communicating the data associated with the portion of the canvas from the computing device to the portable computing device via the network interface for display on the screen of the portable computing device.

### BRIEF DESCRIPTION OF THE DRAWINGS

An embodiment of the invention will now be described by way of example only with reference to the following drawings in which:

FIG. 1 is a perspective view of an interactive input system;

FIG. 2 illustrates exemplary software architecture used by the interactive input system of FIG. 1;

FIG. 3 illustrates an example of an expanded canvas displayed on a portable computing device;

FIGS. 4a and 4b illustrate different examples of an expanded canvas displayed on a portable computing device;

FIG. 5a is a flow chart illustrating operation of an embodiment of an annotation application program;

FIG. 5b is a flow chart illustrating operation of an alternate embodiment annotation application program; and

FIG. 5c is a flow chart illustrating operation of yet an alternate embodiment annotation application program.

### DETAILED DESCRIPTION OF THE PREFERRED EMBODIMENTS

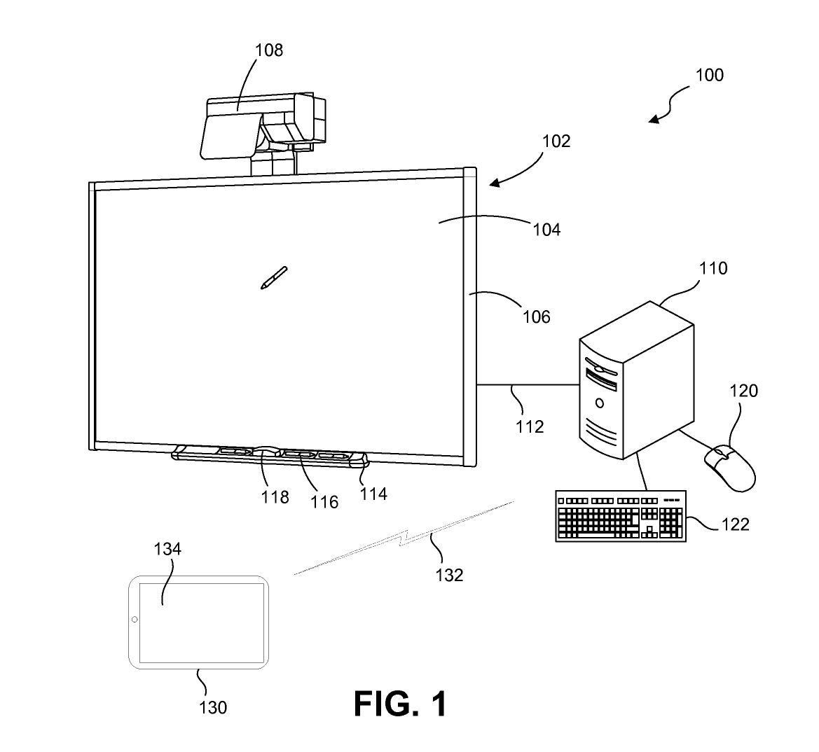

For convenience, like numerals in the description refer to like structures in the drawings. Referring to FIG. 1, an interactive input system is shown and is generally identified by reference numeral 100. Interactive input system 100 allows one or more users to inject input such as digital ink, mouse events, commands, and the like into an executing application program. In this embodiment, interactive input system 100 comprises an interactive display device 102 in the form of an interactive whiteboard (IWB) mounted on a vertical support surface such as a wall surface, for example, or the like. IWB 102 comprises a generally planar, rectangular interactive surface 104 that is surrounded about its periphery by a bezel 106. A projector 108 is mounted on a support surface above the IWB 102 and projects an image, such as a computer desktop for example, onto the interactive surface 104. In this embodiment, the projector 108 is an ultra-short-throw projector such as that sold by SMART Technologies ULC of Calgary, Alberta, Canada, assignee of the subject application, under the name “SMART UX60”.

The IWB 102 employs machine vision to detect one or more pointers brought into a region of interest in proximity with the interactive surface 104. The IWB 102 communicates with a general purpose computing device 110, executing one or more application programs, via a suitable wired or wireless communication link 112. In this embodiment, the communication link 112 is a universal serial bus (USB) cable. A portable computing device 130, executing one or more application programs, communicates with the general purpose computing device 110 via a suitable wired or wireless communication link 132. In this embodiment, the communication link 132 is a wireless communication link such as a Wi-Fi™ link or a Bluetooth® link.

The general purpose computing device 110 processes output from the IWB 102 and adjusts image data that is output to the projector 108, if required, so that the image presented on the interactive surface 104 reflects pointer activity. The general purpose computing device 110 also processes output from the portable computing device 130 and adjusts image data that is output to the projector 108, if required, so that the image presented on the interactive surface 104 reflects activity on the portable computing device 130. In this manner, the IWB 102, general purpose computing device 110, portable computing device 130 and projector 108 allow pointer activity proximate to the interactive surface 104 and/or input to the portable computing device 130 to be recorded as writing or drawing or used to control execution of one or more application programs executed by the general purpose computing device 110.

The bezel 106 is mechanically fastened to the interactive surface 104 and comprises four bezel segments that extend along the edges of the interactive surface 104. In this embodiment, the inwardly facing surface of each bezel segment comprises a single, longitudinally extending strip or band of retro-reflective material. To take best advantage of the properties of the retro-reflective material, the bezel segments are oriented so that their inwardly facing surfaces lie in a plane generally normal to the plane of the interactive surface 104.

A tool tray 114 is affixed to the IWB 102 adjacent the bottom bezel segment using suitable fasteners such as for example, screws, clips, adhesive etc. As can be seen, the tool tray 114 comprises a housing having an upper surface configured to define a plurality of receptacles or slots. The receptacles are sized to receive one or more pen tools 116 as well as an eraser tool 118 that can be used to interact with the interactive surface 104. Control buttons (not shown) are also provided on the upper surface of the tool tray housing to enable a user to control operation of the interactive input system 100. Further specifics of the tool tray 114 are described in U.S. Patent Application Publication No. 2011/0169736 to Bolt et al., filed on Feb. 19, 2010, and entitled “INTERACTIVE INPUT SYSTEM AND TOOL TRAY THEREFOR”, the content of which is incorporated herein by reference in its entirety.

Imaging assemblies (not shown) are accommodated by the bezel 106, with each imaging assembly being positioned adjacent a different corner of the bezel. Each of the imaging assemblies comprises an image sensor and associated lens assembly that provides the image sensor with a field of view sufficiently large as to encompass the entire interactive surface 104. A digital signal processor (DSP) or other suitable processing device sends clock signals to the image sensor causing the image sensor to capture image frames at the desired frame rate. During image frame capture, the DSP also causes an infrared (IR) light source to illuminate and flood the region of interest over the interactive surface 104 with IR illumination. Thus, when no pointer exists within the field of view of the image sensor, the image sensor sees the illumination reflected by the retro-reflective bands on the bezel segments and captures image frames comprising a continuous bright band. When a pointer exists within the field of view of the image sensor, the pointer occludes reflected IR illumination and appears as a dark region interrupting the bright band in captured image frames.

The imaging assemblies are oriented so that their fields of view overlap and look generally across the entire interactive surface 104. In this manner, any pointer such as for example a user's finger, a cylinder or other suitable object, a pen tool 116 or an eraser tool 118 lifted from a receptacle of the tool tray 114, that is brought into proximity of the interactive surface 104 appears in the fields of view of the imaging assemblies and thus, is captured in image frames acquired by multiple imaging assemblies. When the imaging assemblies acquire image frames in which a pointer exists, the imaging assemblies convey pointer data to the general purpose computing device 110.

The portable computing device 130 may comprise a smart phone, a notebook computer, a tablet, or the like. In this embodiment, the portable computing device is a tablet such as an iPad® by Apple®, a GALAXY Tab™ by Samsung®, a Surface™ by Microsoft® and the like. The tablet 130 includes a rear-facing camera (not shown) and a capacitive touchscreen interface 134. The tablet 130 may also include a front-facing camera. The tablet 130 also includes position orientation device (not shown) such as a gyroscope and an accelerometer.

The general purpose computing device 110 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computer components to the processing unit. The general purpose computing device 110 may also comprise networking capabilities using Ethernet, Wi-Fi, and/or other suitable network format, to enable connection to shared or remote drives, one or more networked computers, or other networked devices. A mouse 120 and a keyboard 122 are coupled to the general purpose computing device 110.

For the IWB 102, the general purpose computing device 110 processes pointer data received from the imaging assemblies to resolve pointer ambiguity by combining the pointer data detected by the imaging assemblies, and to compute the locations of pointers proximate the interactive surface 104 (sometimes referred as “pointer contacts”) using well-known triangulation. The computed pointer locations are then recorded as writing or drawing or used as an input command to control execution of an application program as described above.

In addition to computing the locations of pointers proximate to the interactive surface 104, the general purpose computing device 110 also determines the pointer types (e.g., pen tool, finger or palm) by using pointer type data received from the IWB 102. Here, the pointer type data is generated for each pointer contact by at least one of the imaging assembly DSPs by differentiating a curve of growth derived from a horizontal intensity profile of pixels corresponding to each pointer tip in captured image frames. Specifics of methods used to determine pointer type are disclosed in U.S. Pat. No. 7,532,206 to Morrison, et al., and assigned to SMART Technologies ULC, the content of which is incorporated herein by reference in its entirety.

For the tablet 130, the general purpose computing device 110 processes pointer data received directly from the tablet 130 which, in the present embodiment, includes pointer location information as well as pointer identification information.

A software program running in the computing device 110 presents, via the projector 108, an image representing a graphic user interface on the interactive surface 104. The software program processes touch input generated from the interactive surface 104 as well as the tablet 130, and adjusts the image on the interactive surface 104 and the tablet 130 to allow users to manipulate the graphic user interface.

As will be appreciated, the IWB 102 presents a canvas to the user. The term canvas is used herein to refer to graphical user interface comprising information with one or more users can interact. Specifically, the user can view the canvas and make annotations thereon. The canvas can be a fixed size or it can grow dynamically in response to annotations made by the users. In this embodiment, the canvas is sufficiently large that it cannot be displayed on the interactive surface 104 in its entirety at a resolution that is satisfactory to the user. That is, in order to display the canvas in its entirety on the interactive surface, the user would not be able to easily read the content of the canvas. Accordingly, only a portion of the canvas is displayed on the interactive surface at a given time. The user selects a zoom level at which to display the canvas and can zoom in or zoom out to change the zoom level. As will be appreciated, the amount of the canvas that is displayed on the interactive surface will depend on the zoom level. Further, the user can pan across the canvas so that different portions thereof are displayed on the interactive surface 104.

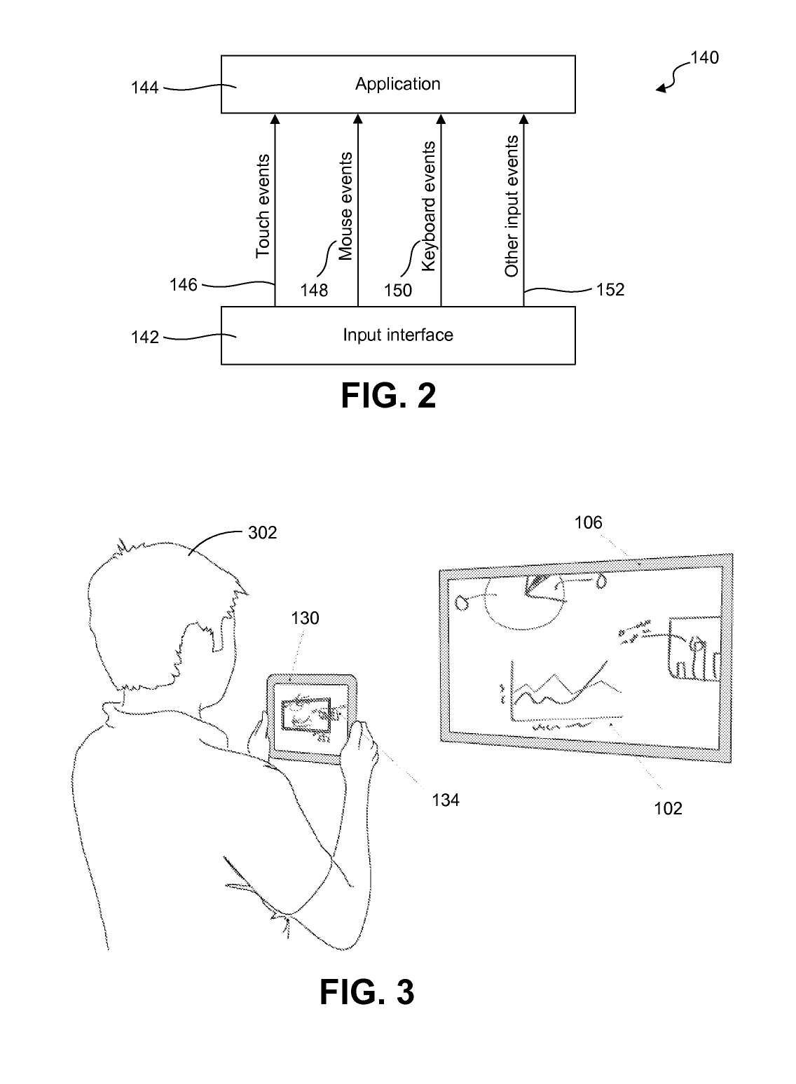

Referring to FIG. 2 an exemplary software architecture used by the interactive input system 100 is shown and is generally identified by reference numeral 140. The software architecture 140 comprises an input interface layer 142 and an application layer 144 comprising one or more application programs. The input interface layer 142 is configured to receive input from various input sources generated from the input devices of the interactive input system 100. The input devices include the IWB 102, the mouse 120, the keyboard 122, and other input devices, depending on the implementation. The input interface layer 142 processes received input and generates input events, such as touch events 146, mouse events 148, keyboard events 150 and/or other input events 152. The generated input events are then transmitted to the application layer 144 for processing. Pointer data from the tablet 130 can be transmitted to either the input interface layer 142 or directly to the application layer 144, depending on the implementation.

As one or more pointers contact the interactive surface 104 of the IWB 102, associated touch events are generated. The touch events are generated from the time the one or more pointers are brought into contact with the interactive surface 104 (referred to as a contact down event) until the time the one or more pointers are lifted from the interactive surface 104 (referred to as a contact up event). As will be appreciated, a contact down event is similar to a mouse down event in a typical graphical user interface utilizing mouse input, wherein a user presses the left mouse button. Similarly, a contact up event is similar to a mouse up event in a typical graphical user interface utilizing mouse input, wherein a user releases the pressed mouse button. A contact move event is generated when a pointer is contacting and moving on the interactive surface 104, and is similar to a mouse drag event in a typical graphical user interface utilizing mouse input, wherein a user moves the mouse while pressing and holding the left mouse button.

In accordance with an embodiment, the tablet 130 is configured to capture the canvas presented on the IWB 102 and present it on the interface 134 of the tablet 130. Further, content from the canvas that is beyond what is presented on the IWB 102 is presented on the interface 134 of the tablet 130 so that the entire interface 134 of the tablet 130 is displaying content from the canvas. Referring to FIG. 3, a user 302 is illustrated using the tablet 130 to capture the canvas presented on the IWB 102 and present it on the interface 134 of the tablet 130. As illustrated in FIG. 3, the IWB 102 only occupies a portion of the interface 134 of the tablet 130. The remaining portion of the interface 134 of the tablet 130 is used to display an additional portion of the canvas that is not displayed on the IWB 102. Accordingly, more of the canvas is visible on the interface 134 of the tablet 130 than is visible on the IWB 102.

The additional portion of the canvas that is visible on the interface 134 of the tablet 130 depends on the position of the IWB 102 within the interface 134 of the tablet 130. That is, if the IWB 102 is positioned closer to the top of the interface 134 of the tablet 130, then more of the canvas positioned below the portion displayed on the IWB 102 is displayed on the interface 134 of the tablet 130. Similarly, if the IWB 102 is positioned closer to the left of the interface 134 of the tablet 130, then more of the canvas positioned to the right of the portion displayed on the IWB 102 is displayed on the interface 134 of the tablet 130.

In order to facilitate this feature, the tablet 130 executes an annotation application. The annotation application may be a dedicated application program or a general application program. Dedicated application programs are typically designed to have a custom graphical user interface and to implement a specific task. Often, dedicated application programs are also configured to communicate with a server application program at a destination computer. A general application provides a platform for communicating with destination computers that can be dynamically selected by a user. Often, the general application provides a platform in which other applications can execute. An example of a general-purpose application is a web browser. In this embodiment, the annotation application is a dedicated application that is configured to be downloaded and installed on the tablet 130. Further, the annotation application is configured to communicate with the software program executing on the general purpose computer 110.

In addition to presenting an expanded portion of the canvas to the user 302 on the interface 134 of the tablet 130, the annotation application also facilitates interaction with the canvas in a similar manner to interaction with the IWB 102. That is, when the user 302 interacts with the canvas using the annotation application, pointer data is collected at the tablet 130. The annotation application program can be configured to identify pointers, pen tools and eraser tools in a similar manner to that described for the IWB 102. In addition, the annotation application may include virtual buttons that allow a user to identify the desired action prior to interacting with the canvas. For example, the user can select a pointer tool, pen tool, eraser tool, or the like from the virtual buttons. The annotation application is configured to communicate with the general purpose computing device 110 to convey pointer data input to the canvas using the tablet. The pointer data includes pointer location information as well as pointer identification information.

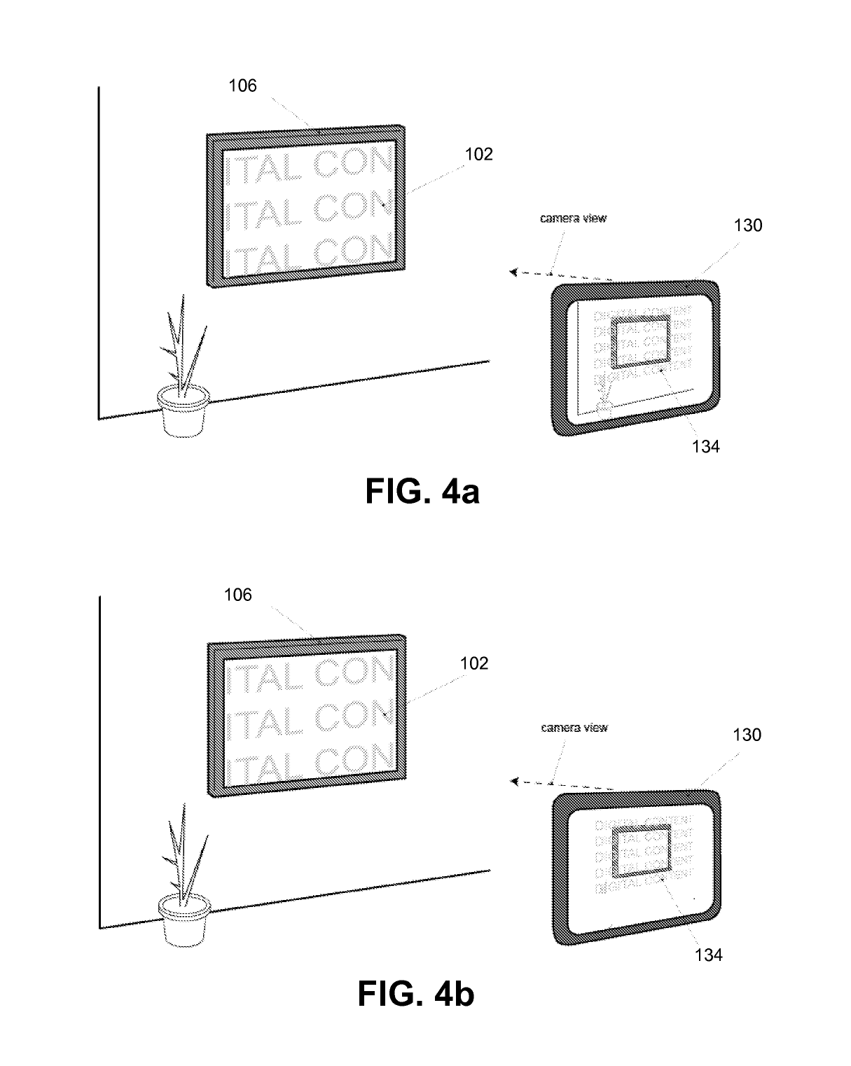

Referring to FIGS. 4a and 4b, further examples of the expanded canvas displayed on the tablet 130 are shown. In the example shown in FIG. 4a, the annotation application program is configured to provide an augmented reality view of the canvas, which is super-imposed over the existing background. Accordingly, a tree 402 positioned to the side of the IWB 102 is still visible on the interface 134 of the tablet 130 when the expanded canvas is displayed. Alternatively, in the example shown in FIG. 4b, the annotation application program is not configured to provide an augmented reality view of the canvas. Accordingly, the tree 402 positioned to the side of the IWB 102 is not visible on the interface 134 of the tablet 130 when the expanded canvas is displayed.

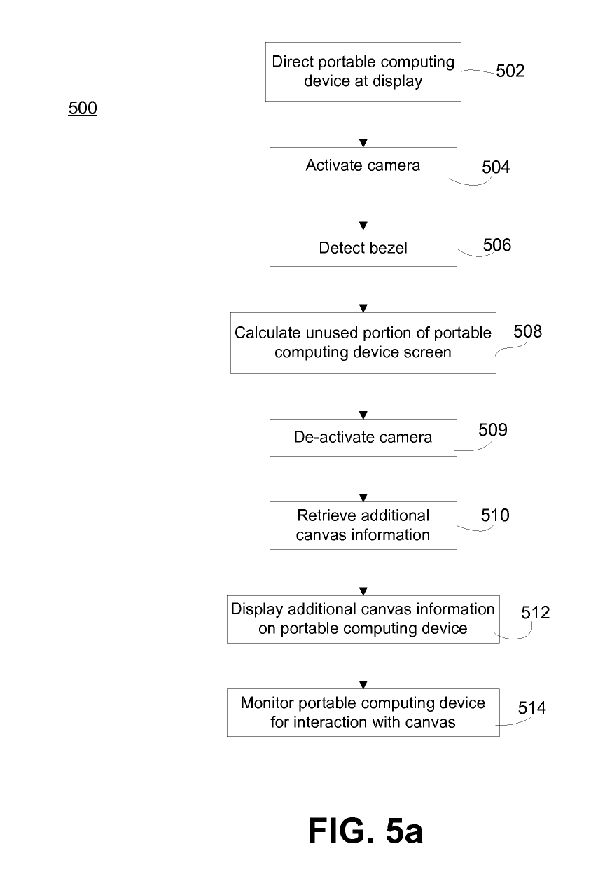

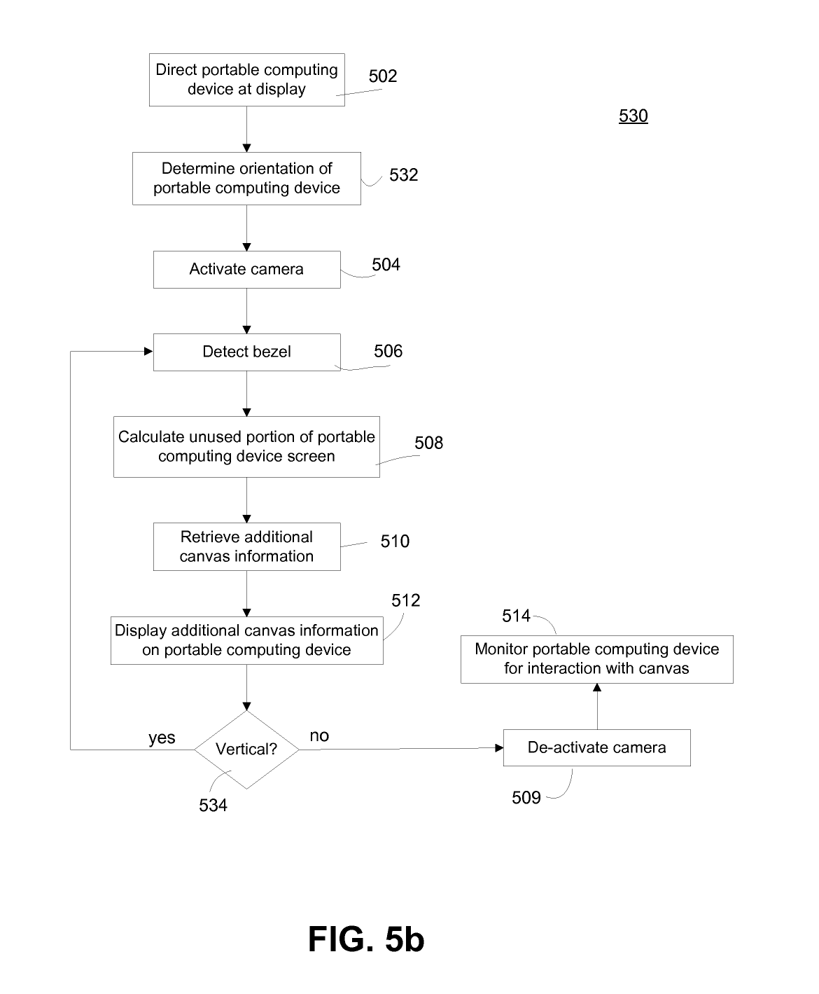

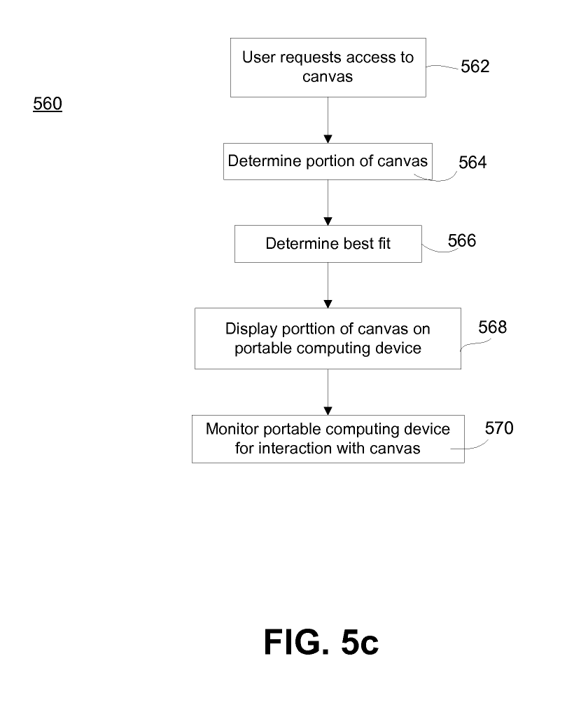

Referring to FIG. 5a, a flow chart illustrating the steps implemented by the annotation application program is illustrated generally by numeral 500. At step 502 the user 302 is instructed to aim the tablet 130 in the direction of the IWB 102. At step 504 the rear-facing camera of the tablet 130 is activated. At step 506 the location of the bezel 106 of the IWB 102 is detected. At step 508 a difference between the location of the bezel 106 on the interface 134 of the tablet 130 and the edges of the interface 134 of the tablet 130 is calculated. This calculation determines how much additional canvas can be displayed on the interface 134 of the tablet 130. At step 509, the rear-facing camera of the tablet 130 is de-activated so that further motion of the tablet will not affect the operation of the annotation application program. At step 510, the annotation application program communicates with the general purpose computing device 110 to retrieve information regarding the additional canvas. In step 512 the additional canvas is displayed on the interface 134 of the tablet 130. At step 514 the interface 134 of the tablet 130 is monitored for interaction from the user. Annotations made by the user are injected into the portion of the canvas displayed on the tablet 130 and communicated to the computer so that it can be injected into the canvas and displayed on the IWB 102. The user can also pan the canvas using a panning request. In one embodiment, the panning request is a panning gesture, such a swipe across the interface 134 of the tablet 130. In another embodiment, the panning request is a panning motion. The panning motion is achieved by the user physically moving the tablet 130 in a specific direction. The position-orientation device in the tablet 130 determines the direction and transmits the direction information to the annotation application program. The direction information is then used for the panning request. In response to the panning request, further canvas information is retrieved from the general purpose computing device 110.

Referring to FIG. 5b, a flow chart illustrating the steps implemented by an alternate embodiment of the annotation application program is illustrated generally by numeral 530. At step 502 the user 302 is instructed to aim the tablet 130 in the direction of the IWB 102. At step 532 it is determined if the tablet 130 is oriented vertically. This can achieved using the position-orientation device incorporated into most tablets. If it is determined that the tablet 130 is oriented vertically, then at step 504 the rear-facing camera of the tablet 130 is activated. At step 506 the location of the bezel 106 of the IWB 102 is determined. At step 508 a different between the location of the bezel 106 on the interface 134 of the tablet 130 and the edges of the interface 134 of the tablet 130 is calculated. This calculation determines how much additional canvas can be displayed on the interface 134 of the tablet 130. At step 510, the annotation application program communicates with the general purpose computing device 110 to retrieve information regarding the additional canvas. In step 512 the additional canvas is displayed on the interface 134 of the tablet 130. In step 534, it is determined whether the tablet 130 is oriented vertically or horizontally.

If the tablet 130 is oriented horizontally, then at step 536 the rear-facing camera of the tablet 130 is de-activated. At step 514 the interface 134 of the tablet 130 is monitored for interaction from the user. Annotations made by the user are injected into the portion of the canvas displayed on the tablet 130 and communicated to the computer so that it can be injected into the canvas and displayed on the IWB 102.

If the tablet 130 is oriented vertically, then the annotation application program returns to step 506.

Referring to FIG. 5c, a flow chart illustrating the steps implemented by an alternate embodiment of the annotation application program is illustrated generally by numeral 560. In this particular embodiment, a camera is not used to set up the canvas on the interface 134 of the tablet 130. Rather, at step 562, the user 302 selects an option in the annotation application program to access the canvas. At step 564, the annotation application program communicates with the computer 110 to determine the portion of the canvas being displayed on the interactive surface 104 of the IWB 102. The portion of the canvas displayed on the interactive surface 104 can be determined by identifying a point of the canvas that is displayed at one of the corners of the interactive surface 104. The remainder of the canvas can be retrieved based on the dimensions of the interface 134 of the tablet 130. Alternatively, the portion of the canvas displayed on the interactive surface 104 can be determined by identifying a point of the canvas that is displayed at the center of the interactive surface 104. The remainder of the canvas can be retrieved based on the dimensions of the interface 134 of the tablet 130.

At step 566, a best fit of the canvas displayed on the interactive surface 104 is determined for the interface 134 of the tablet 130. Depending on an aspect ratio of the interactive surface 104 and the interface 134, the best fit may result in cropping or expanding the portion of the canvas displayed on the interactive surface 104 when displaying the canvas on the interface 134. If the aspect ratio of the interactive surface 104 and the interface 134 are the same and their resolutions are same, then no modification may be necessary. At step 568, the portion of the canvas determined in step 566 is displayed on the interface 134 of the tablet.

At step 570 the interface 134 of the tablet 130 is monitored for interaction from the user. Annotations made by the user are injected into the portion of the canvas displayed on the tablet 130 and communicated to the computer so that it can be injected into the canvas and displayed on the IWB 102.

In an alternate embodiment, more canvas information than necessary is obtained from the general purpose computing device 110 at step 510. The excess canvas information is used as a buffer to facilitate smooth panning. If the user pans the canvas, further canvas information is retrieved from the computer to replenish the buffer.

In yet an alternate embodiment, the annotation application program retrieves the entire canvas when it is executed on the tablet 130. Information regarding the canvas is then synchronized between tablet 130 and the general purpose computing device 110. Accordingly, any annotations to the canvas made on computing devices remote to the tablet 130, including the IWB 102 for example, are communicated to the tablet 130 by the general purpose computing device 110 so that the canvas information remains current.

In yet an alternate embodiment, the annotation application program also transmits panning information to the computer. That, if the user pans the canvas displayed on the interface 134 of the tablet 130, the portion of the canvas displayed on remote displays, such as the IWB 102, are also panned. This allows the users to move an item on the canvas so that it is displayed on the IWB 102. For example, consider that an item of importance is displayed as part of the additional canvas information on the interface 134 of the tablet 130 but not on the IWB 102. The user can pan the canvas until the item of importance is displayed on the IWB 102. In order to facilitate this feature, a representation of the bezel 106 may be maintained on the interface 134 of the tablet 130 so that the user can easily recognize where to pan the canvas.

In yet an alternate embodiment the annotation application program is configured to include a tablet tracking feature. The tablet tracking feature instructs the computer 110 to align the portion of the canvas displayed on the interactive surface 104 with the portion of the canvas displayed on the tablet 130. Since the portion of the canvas displayed on the tablet 130 is generally larger than the portion of the canvas displayed on the interactive surface 104, the tablet tracking feature transmits a tablet alignment coordinate to the computer 110. The tablet alignment coordinate is a predefined position on the interface 134 of the tablet 130. For example, the tablet alignment coordinate can represent a point on the canvas that is in a corner of the interface 134. As another example, the tablet alignment coordinate can represent a point on the canvas that is in the middle of the interface 134. The computer 110 uses the tablet alignment coordinate to modify the portion of the canvas displayed on the interactive surface 104.

In yet an alternate embodiment the annotation application program is configured to include an interactive surface tracking feature. The interactive surface tracking feature aligns the portion of the canvas displayed on the interface 134 of the tablet 130 with the portion of the canvas displayed on the interactive surface 104 in response to a request from the computer 110. The request from the computer 110 also includes an interactive surface alignment coordinate. The interactive surface alignment coordinate is a predefined position on the interactive surface 104. For example, the interactive surface alignment coordinate can represent a point on the canvas that is in a corner of the interactive surface 104. As another example, the interactive surface alignment coordinate can represent a point on the canvas that is in the middle of the interactive surface 104. The annotation application program uses the interactive surface alignment coordinate to modify the portion of the canvas displayed on the interface 134.

As will be appreciated by a person of ordinary skill in the art, a plurality of tablets or other portable computing devices 130 can connect to the computer 110 for displaying the canvas. Each of these tablets or other portable devices 130 can be paired with the IWB 102, as described above, or connected with the canvas as separate instances.

Accordingly, it will be appreciated that the annotation application program facilitation viewing of more of the canvas than is being displayed on the IWB 102. This provides access to additional, peripheral content from the canvas that would not otherwise be readily available at the selected zoom level. Further, the ability to pan the canvas displayed on the IWB 102, or other remote displays, by panning the canvas displayed on the interface 134 of the tablet 130 provides an easy way for the user to reposition relevant data so that it is displayed on the IWB 102, or other remote displays. As will be appreciated various modifications and combinations of the embodiments described above can be made with detracting from the invention described herein.

In above description, the software program may comprise program modules including routines, object components, data structures, and the like, and may be embodied as computer readable program code stored on a non-transitory computer readable medium. The computer readable medium is any data storage device that can store data. Examples of computer readable media include for example read-only memory, random-access memory, CD-ROMs, magnetic tape, USB keys, flash drives and optical data storage devices. The computer readable program code may also be distributed over a network including coupled computer systems so that the computer readable program code is stored and executed in a distributed fashion. Yet further, additional software may be provided to perform some of the functionality of the touch script code, depending on the implementation.

Although in embodiments described above, the IWB is described as comprising machine vision to register pointer input, those skilled in the art will appreciate that other interactive boards employing other machine vision configurations, analog resistive, electromagnetic, capacitive, acoustic or other technologies to register input may be employed. Further, machine vision different to that described above may also be used.

For example, products and touch systems may be employed such as for example: LCD screens with camera based touch detection (for example SMART Board™ Interactive Display—model 8070i); projector based IWB employing analog resistive detection (for example SMART Board™ IWB Model 640); projector based IWB employing a surface acoustic wave (WAV); projector based IWB employing capacitive touch detection; projector based IWB employing camera based detection (for example SMART Board™ model SBX885ix); table (for example SMART Table™—such as that described in U.S. Patent Application Publication No. 2011/069019 assigned to SMART Technologies ULC of Calgary, the entire contents of which are incorporated herein by reference); slate computers (for example SMART Slate™ Wireless Slate Model WS200); podium-like products (for example SMART Podium™ Interactive Pen Display) adapted to detect passive touch (for example fingers, pointer, etc,—in addition to or instead of active pens); all of which are provided by SMART Technologies ULC of Calgary, Alberta, Canada.

As another example, the portable computing device 130 may implement the touch screen interface using touch systems similar to those described for the IWB 102 rather than the capacitive touch screen interface of the tablet. Further, the portable computing device 130 may be a notebook computer which may use traditional keyboard and mouse input instead of, or in addition to, a touch screen interface. As yet another example, rather than execute the annotation application program, access to the canvas can be provided by the user navigating to a predefined website using a web browser executing on the portable computing device 130.

Although embodiments have been described above with reference to the accompanying drawings, those of skill in the art will appreciate that variations and modifications may be made without departing from the scope thereof as defined by the appended claims.

What is claimed is:

1. A computer-implemented method for displaying a canvas on a portable computing device comprising a camera, a screen, and a network interface, the method comprising:
using a camera to capture an image of a display, displaying a portion of the canvas, on the screen;
determining a position of the display relative to edges of the screen;
using the position of the display to determine screen surface available for displaying an additional portion of the canvas;
retrieving the additional portion of the canvas; and
displaying both the portion of the canvas and the additional portion of the canvas on the screen.

2. The method of claim 1 further comprising:
retrieving a further portion of the canvas in response to a panning request; and
panning the portion of the canvas and the additional portion of the canvas displayed on the screen of the portable computing device.

3. The method of claim 2 further comprising communicating the panning request to a remote computing system via the network interface to facilitate corresponding panning of the portion of the canvas displayed on the display.

4. The method of claim 2, wherein the panning request is:
a panning gesture based on interaction with the portable computing device; or
a panning motions based on physical motion of the portable computing device.

5. The method of claim 1 wherein retrieving the additional portion of the canvas comprises retrieving the additional portion from a remote computing system via the network interface.

6. The method of claim 1 wherein the canvas is preloaded into memory on the portable computing device and the step of retrieving the additional portion of the canvas comprises retrieving the additional portion of the canvas from the memory.

7. The method of claim 6, further comprising communicating with a remote computing system via the network interface to synchronize the canvas therewith.

8. The method of claim 1, wherein the canvas is stored at a remote computing system and retrieving the additional portion of the canvas comprises retrieving the additional portion of the canvas from the remote computing system via the network interface.

9. The method of claim 8, wherein more canvas information than necessary is retrieved from the remote computing system to be used as a buffer.

10. The method of claim 2 further comprising instructing a remote computing system to align the portion of the canvas displayed on the display with the panned portion of the canvas displayed on the portable computing device.

11. The method of claim 10, wherein the portable computing device communicates a tablet alignment coordinate to the remote computing system to facilitate alignment of the portion of the canvas displayed on the display.

12. The method of claim 2 further comprising aligning the panned portion of the canvas displayed on the portable computing device with the portion of the canvas displayed on the display in response to instruction received from a remote computing system.

13. The method of claim 12, wherein the portable computing device receives an interactive surface alignment coordinate from the remote computing system to facilitate alignment of the panned portion of the canvas.

14. A portable computing device for displaying a canvas, the portable computing device comprising:
a screen;
a camera configured to capture an image of a display, displaying a portion of the canvas;
a memory comprising instruction; and
a processor configure to:
determine a position of the display relative to edges of the screen;
use the position of the display to determine screen surface available for displaying an additional portion of the canvas;
retrieve the additional portion of the canvas; and
display both the portion of the canvas and the additional portion of the canvas on the screen.

15. The portable computing device of claim 14 further comprising a network interface and the additional portion of the canvas is retrieved from a remote computing system via the network interface.

16. The portable computing device of claim 14 wherein the canvas is preloaded into the memory the additional portion of the canvas is retrieved from the memory.

17. The portable computing device of claim 16, further comprising a network interface and the processor is further configured to communicate with a remote computing system via the network interface to synchronize the canvas therewith.

18. The portable computing device of claim 14, wherein the screen is an interactive screen.

19. A computer-implemented method for displaying a canvas on a portable computing device comprising a screen and a network interface, the method comprising:
determining, at a computing device, a portion of the canvas that is displayed on an interactive surface of an interactive display device;
retrieving data associated with the portion of the canvas that is displayed on the interactive surface based on a predefined identification point; and
communicating the data associated with the portion of the canvas from the computing device to the portable computing device via the network interface for display on the screen of the portable computing device.

20. The method of claim 19, wherein the predefined identification point is a point of the canvas that is displayed at a corner of the interactive surface or at the middle of the interactive surface.

21. The method of claim 20 further comprising determining a best fit of the canvas on a screen of the portable computing device and displaying the best fit of the canvas on the screen.

22. The method of claim 21 further comprising monitoring the portable computing device for interaction with a user and communicating the interaction to the computing device.

23. The method of claim 21 further comprising:
communicating further data associated with the canvas of the canvas from the computing device to the portable computing device via the network interface in response to a panning request; and
panning the best fit of the canvas on the screen of the portable computing device.

24. The method of claim 23 further comprising communicating the panning request to the computing device via the network interface to facilitate corresponding panning of the portion of the canvas displayed on the display.

25. The method of claim 23, wherein the panning request is:
a panning gesture based on interaction with the portable computing device; or
a panning motions based on physical motion of the portable computing device.

26. The method of claim 23 further comprising instructing the computing device to align the portion of the canvas displayed on the interactive surface with the panned portion of the canvas displayed on the portable computing device.

27. The method of claim 26, wherein the portable computing device communicates a tablet alignment coordinate to the computing device to facilitate alignment of the portion of the canvas displayed on the display.

28. The method of claim 23 further comprising aligning the panned portion of the canvas displayed on the portable computing device with the portion of the canvas displayed on the interactive surface in response to instruction received from the computing device.

29. The method of claim 28, wherein the portable computing device receives an interactive surface alignment coordinate from the computing device to facilitate alignment of the panned portion of the canvas.
